(19) United States
(12) Patent Application Publication
(10) Pub. No.: US 2022/0112027 A1
(43) Pub. Date: Apr. 14, 2022

(54) AIRCRAFT SEAT CARGO CONTAINER

(71) Applicant: RECARO Aircraft Seating GmbH & Co. KG, Schwaebisch Hall (DE)

(72) Inventors: Clinton MELTON, Denton, TX (US); Vaidhyanathan RAMAMOORTHY, Keller, TX (US); René DANKWERTH, Argyle, TX (US)

(21) Appl. No.: 17/065,568

(22) Filed: Oct. 8, 2020

(51) Int. Cl. B65D 88/14; B64D 11/00; B65D 90/12

(52) U.S. Cl. CPC B65D 88/14; B65D 90/12; B64D 11/003

(57) ABSTRACT

An aircraft seat cargo container is proposed, comprising a sheet material main body, in particular a cardboard main body, having a bottom wall, a back wall, a front wall and first and second side walls that define a storage volume; and a seating area fastening unit configured to receive an aircraft seat belt for securing the sheet material main body.

### PRIOR ART

The invention relates to an aircraft seat cargo container according to the patent claim 1.

An aircraft seat cargo container has already been proposed.

The objective of the invention is, in particular, to provide an aircraft seat cargo container with improved properties regarding a lightweight construction, easy handling and environmental benefits. According to the invention, the objective is achieved by the features of patent claim 1, while advantageous embodiments and developments of the invention may be gathered from the dependent claims.

### SUMMARY OF THE INVENTION

An aircraft seat cargo container is proposed, comprising a sheet material main body, in particular cardboard main body, having a bottom wall, a back wall, a front wall and first and second side walls that define a storage volume; and a seating area fastening unit configured to receive an aircraft seat belt for securing the sheet material main body.

Preferably, the aircraft seat cargo container is configured to be placed securely on an aircraft seat and/or aircraft seat row and provided to hold items securely during flight. Preferably, the aircraft seat cargo container is configured for a fixation on an aircraft seat, especially a seating area of the aircraft seat. The seating area of an aircraft seat is preferably formed by a seat bottom of the aircraft seat. In the case that the aircraft seat cargo container is fixed to more than one aircraft seat, the aircraft seat cargo container is configured for a fixation on the seating area of all seat bottoms of all the aircraft seats or on the seating area of at least two seat bottoms of the aircraft seats. It is conceivable that the aircraft seat cargo container is fixated at least on the outer seat bottoms by means of the respective aircraft seat belts of the outer aircraft seats, for example an aisle seat or an outboard or window seat, of an aircraft seat bench when the aircraft seat cargo container is configured for an installation on the seating areas of at least three aircraft seats. An “aircraft seat” is intended to be understood here as meaning in particular a seat which is provided to be mounted in an aircraft cabin of an aircraft. The aircraft seat here preferably has a mounting unit, by means of which the aircraft seat can be fixedly mounted on a cabin floor of the aircraft cabin. The aircraft seat here is preferably designed as part of a seat row which has a plurality of substantially identically designed aircraft seats which are mounted on the cabin floor via a common mounting unit. The aircraft seat preferably has a seat bottom, a backrest coupled to the seat bottom, at least one seat divider and at least one armrest. A “seat bottom” is intended to be understood here as meaning in particular a unit which forms the seating area for a passenger. The seat bottom here is preferably formed by a basic body and a cushion attached to the basic body. Preferably, the basic body is embodied as a seat pan. Alternatively, it is conceivable that the seat bottom is solely embodied of the basic body, in particular without a cushion attached on top of the basic body, wherein the aircraft seat cargo container contacts the basic body directly when installed. A “seating area” is intended to be understood here as meaning in particular a region of the aircraft seat that is provided for a passenger to sit thereon, in particular during a flight. A “backrest” is intended to be understood here as meaning in particular a unit of the aircraft seat that forms a backrest support surface, against which a passenger sitting on the aircraft seat can lean his/her back. The backrest here preferably comprises at least one basic body and a cushion which forms the backrest support surface. The backrest is arranged here at a rear end of the seat bottom and extends from the seat bottom upward, away from a mounting unit. An “armrest” is intended to be understood here as meaning in particular a unit which forms at least one support surface, on which a passenger sitting on the aircraft seat can at least partially rest his/her arm. In order to form the at least one support surface, the armrest unit here has at least one support element. The armrest here bounds the seat region of the aircraft seat laterally. A “seat divider” is intended to be understood as meaning in particular a component of the aircraft seat or of a seat row with at least two aircraft seats arranged laterally next to each other, which component is arranged at least substantially above at least one supporting tube with respect to a vertical direction, which is oriented vertically with respect to a mounting plane of the aircraft seat, at least in the use position. In particular, the seat divider is a rigidly formed component of the seat row. The seat divider is provided in particular for the mounting of the armrest. The seat divider is preferably provided for permitting the connection of the aircraft seat belt, in particular one portion of the aircraft seat belt. Alternatively, the aircraft seat belt may be attached to other structural parts of the aircraft seat, for example to a reinforced backrest structure, directly to a supporting tube of the aircraft seat or to a kinematics of the aircraft seat. In particular, the seat divider is provided for receiving a supporting tube receptacle. The seat divider preferably forms a lateral delimitation of at least one of the aircraft seats arranged next to each other in a seat row, wherein the seat divider can be arranged at the aisle side and/or at the inboard side, and/or may form a delimitation between two aircraft seats arranged laterally next to each other in a seat row. In particular, the seat divider is a constituent part of a force dissipation path which runs via the backrest unit, the seat divider, a supporting tube structure and the mounting unit into the mounting plane, in particular into an aircraft cabin floor. A “use position” is intended to be understood here as meaning in particular a position of the aircraft seat, in which the latter is mounted in the aircraft cabin in a manner in which said aircraft seat can be used as intended by a person, wherein the aircraft seat is in particular constructed in such a manner that a passenger can sit on the aircraft seat as intended, in particular during a flight. The term “configured” is in particular to mean specifically designed and/or equipped. An object being configured for a certain function is in particular to mean that the object implements and/or carries out said certain function in at least one application state and/or operation state. In this context, a “storage volume” in particular is to be understood as a space, which is confined by the walls of the sheet material main body and is provided that a passenger can securely store items within, especially during a flight. Preferably, the sheet material main body is embodied as a cardboard main body, a sandwich structure main body, a sheet metal main body or any other conceivable main body that has a plate-shaped basic form with abilities for folding. Preferably a “cardboard main body” consists mainly of paper or plastic cardboard. It is conceivable that the cardboard main body features one or more stiffening elements integrated into the cardboard. Thereby it is conceivable that a stiffening element is fixed onto the cardboard for example via a glue connection, or that the stiffening element is integrated into the cardboard. Preferably a “sandwich structure main body” consists mainly of at least one sandwich plate. Preferably a “sheet metal main body” consists mainly of at least one aluminum sheet or of at least one sheet of another lightweight metal. Thereby it is conceivable that the used material of the sheet material main body is hinged. It is also conceivable that the sheet material main body consists of composite material elements, for example glass fiber reinforced plastic or carbon fiber reinforced plastic. Preferably, an outer layer and/or an inner layer of the sheet material main body have protective characteristics, for example lamination or coating for a reinforcement and persistence of the aircraft seat cargo container. Preferably, the sheet material main body is embodied fire retardant. The “seating area fastening unit” is a unit, especially an area of the sheet material main body, via which the sheet material main body can be fasted to an aircraft seat and via which loads can be transferred from the sheet material main body into the aircraft seat, especially the seat belt. As a result a cargo container for the use in an aircraft, which can be easily fixed to an aircraft seat can be achieved. Thereby an easy to install and flexible container for the use in an aircraft can be achieved, in which air cargo can be transported. Thus, airlines are able to shift air cargo capacity into the aircraft cabin if a flight is not fully booked or the aircraft is used for pure cargo flights temporarily. Alternatively, the aircraft seat cargo container may be used by a passenger to store personal hand luggage during a flight. By means of the invention, an airline can use unused aircraft seats for air cargo transport. It is conceivable that a part of an aircraft cabin may be dedicated for air cargo, for example a back section of the aircraft cabin, while passengers may be seated in other parts of the aircraft cabin, for example in a front section of the aircraft. Alternatively, it is also conceivable that the aircraft seat cargo container is installed directly next to a passenger. Preferably, the aircraft seat cargo container can be fixated on an aircraft seat in a packed state or in an empty state. In principle, the aircraft seat cargo container may be used in other means of transportation as an aircraft as well, for example in car, in a bus, in a train, in a vessel or in any other vehicle.

It is proposed that the seating area fastening unit is configured to receive the aircraft seat belt to secure the sheet material main body when the storage volume is full. As a result it is possible for airlines personnel, logistics personnel or a passenger to pack the aircraft seat cargo container before entering the aircraft and secure a fully packed aircraft seat cargo container to the seat without unpacking it.

It is proposed that the sheet material main body includes a separation element that separates the fastening unit from the storage volume. A “separation element” in particular is to be understood as a wall element that is located between the fastening unit and the storage volume. The separation element is arranged in the area of the fastening unit. The separation element in part forms a wall that delimits the storage volume. Between the separation element and the seating area fastening unit a mounting space is formed. The mounting space is provided that the seat belt can be passed through. Preferably the mounting space is big enough that a person, especially a passenger can reach through with his arm to secure the seat belt to the seating area fastening unit. As a result, the fastening unit can be partitioned off the storage volume in an easy manner so that it is accessibly easily for airlines personnel, logistics personnel or a passenger. Therefore, the sheet material main body can be fixed to the aircraft seat in an easy way. Alternatively, it is conceivable that the sheet material main body has no previously described separation element, in particularly when the aircraft seat cargo container is configured to be installed in the aircraft cabin over a period of more than one flight, wherein the storage volume has to be filled and emptied inside the aircraft cabin.

Furthermore, it is proposed that the seating area fastening unit further comprises a connection wall, the connection wall defining at least one through hole, configured to receive the aircraft seat belt to secure the sheet material main body to the aircraft seat. A “connection wall” in particular is to be understood as a wall to which the seat belt or other fastening means can be fixed to secure the sheet material main body to the aircraft seat. As a result the seating area fastening unit can be formed easily and the seat belt can be fixed to the seating area fastening unit in a very easy manner.

Furthermore, the connection wall is implemented as a slanted wall between the bottom wall and the back wall. Preferably the through holes of the connection wall are arranged in the slanted wall portion. As a result the connection wall can be constructed in such a way that the aircraft seat belt can be fixed in an easy and secure manner.

It is also proposed that the fastening unit has at least one seat fastening element, via which the sheet material main body can be additionally secured to the aircraft seat. A “seat fastening element” in particular is to be understood as an element, such for example as a belt, a cord or a strap, that is configured to fix the aircraft seat cargo container, especially the sheet material main body to the aircraft seat. The seat fastening element is preferably provided to secure the sheet material main body in addition to the fixation via the seat belt. Preferably the seat fastening element is an elastic strap which can be wrapped around the sheet material main body and the backrest of the aircraft seat to clamp the sheet material main body to the aircraft seat. It is also conceivable, that the seat fastening element is a strap, that is fixable on one end to the sheet material main body and with a second end fixable to the aircraft seat, especially the backrest, the armrest or a seat divider of the aircraft seat. As a result the aircraft seat cargo container can be secured to the aircraft seat in a very safe manner. Additionally or alternatively, it is conceivable that the aircraft seat cargo container is attached to a further aircraft seat that is arranged in front of the aircraft seat on which the aircraft seat cargo container is placed. Such a design can be advantageous in particular for large aircraft seat cargo containers that utilize a space between the backrest of the aircraft seat and the backrest of the further aircraft seat at least substantially.

Beyond this it is proposed that the sheet material main body has a width that corresponds to an aircraft seat width. As a result a cargo box that fits on one aircraft seat can be provided.

Furthermore, it is proposed that the sheet material main body has a width that corresponds to the width of at least two neighboring aircraft seats. As a result an aircraft seat cargo container with a bigger storage volume that fits on more than one aircraft seat, especially two or three neighboring aircraft seats can be provided.

Preferably, the aircraft seat cargo container comprises a closing element that is configured to close an insert opening of the sheet material main body. A “closing element” in particular is to be understood as an element that is provided to close up the storage volume by sealing the insert opening of the sheet material main body. In a state where the closing element closes up the storage volume the closing element is preferably fixed to the sheet material main body, preferably in a form-fit or force-fit manner. As a result the cargo stored inside the storage volume is secured inside the sheet material main body.

In one embodiment the closing element comprises a separate lid. As a result the closing element can be removed from the sheet material main body, for example to ensure an easy loading of the storage volume.

In another embodiment, the closing element comprises an elastic net. As a result a very simple closing element can be provided.

Preferably, the sheet material main body is formed by one foldable one piece cardboard element. As a result, the sheet material main body can be manufactured in an easy way.

Preferably, the sheet material main body is configured to be foldable between a flat state and a state that defines the storage volume multiple times. Therefore, the aircraft seat cargo container can be used multiple times.

Preferably, the one-piece sheet material element comprises a plurality of adhesively joined cardboard elements. As a result, a complex and stable foldable cardboard box can be obtained.

In another embodiment, the sheet material main body includes an insulation inlay. As a result, a cooling container for the transport of items to be cooled can be obtained.

It is not intended to restrict the cargo container according to the invention to the use and embodiment described above. The content of this disclosure is intended to contain all conceivable combinations of the features mentioned herein. In particular the aircraft seat cargo container can have a number of individual elements, components and units different from that mentioned herein in order to perform a function described herein.

### DRAWINGS

Further advantages may become apparent from the following description of the drawings. In the drawings four exemplary embodiments of the invention are shown. The drawings, the description and the claims contain a plurality of features in combination. The person having ordinary skill in the art will purposefully also consider the features separately and will find further expedient combinations.

If there is more than one specimen of a certain object, at least in some cases only one of these is given a reference numeral in the figures and the description. The description of this specimen may be correspondingly transferred to the other specimens of the object.

It is shown in:

FIG. 1 a schematic view of a first embodiment of the aircraft seat cargo container on an aircraft seat,

FIG. 2 a schematic view of a sheet material main body of the aircraft seat cargo container,

FIG. 3 a detailed view of a seating area fastening unit of the aircraft seat cargo container,

FIG. 4 a view of a one-piece cardboard element in an unfolded state,

FIG. 5 a schematic view of a second embodiment of the aircraft seat cargo container on an aircraft seat,

FIG. 6 a schematic view of the second embodiment of the aircraft seat cargo container,

FIG. 7 a further schematic view of a sheet material main body of the aircraft seat cargo container in the second embodiment,

FIG. 8 a view of a one-piece cardboard element in an unfolded state in the second embodiment,

FIG. 9 a schematic view of a third embodiment of the aircraft seat cargo container and

FIG. 10 a schematic view of a fourth embodiment of the aircraft seat cargo container on an aircraft seat.

### DESCRIPTION OF THE ILLUSTRATIVE EMBODIMENTS

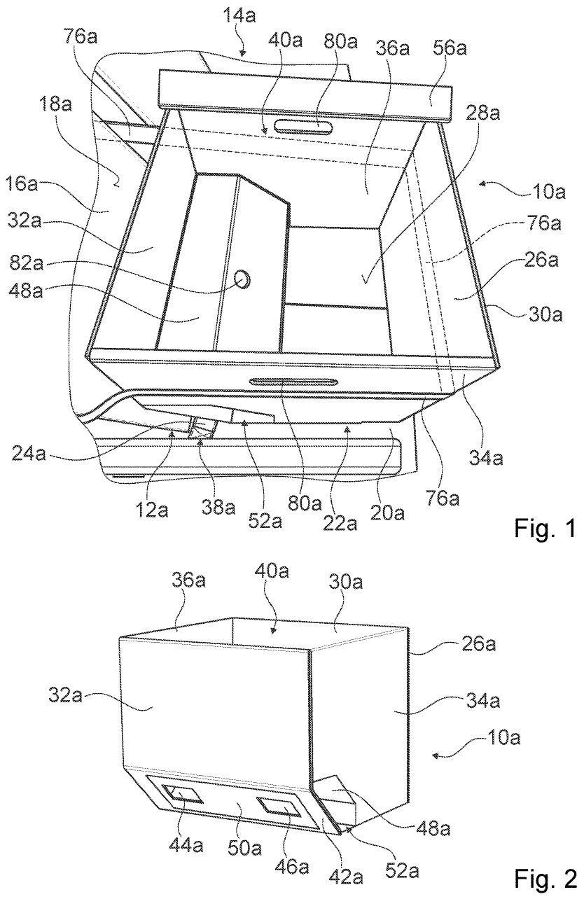

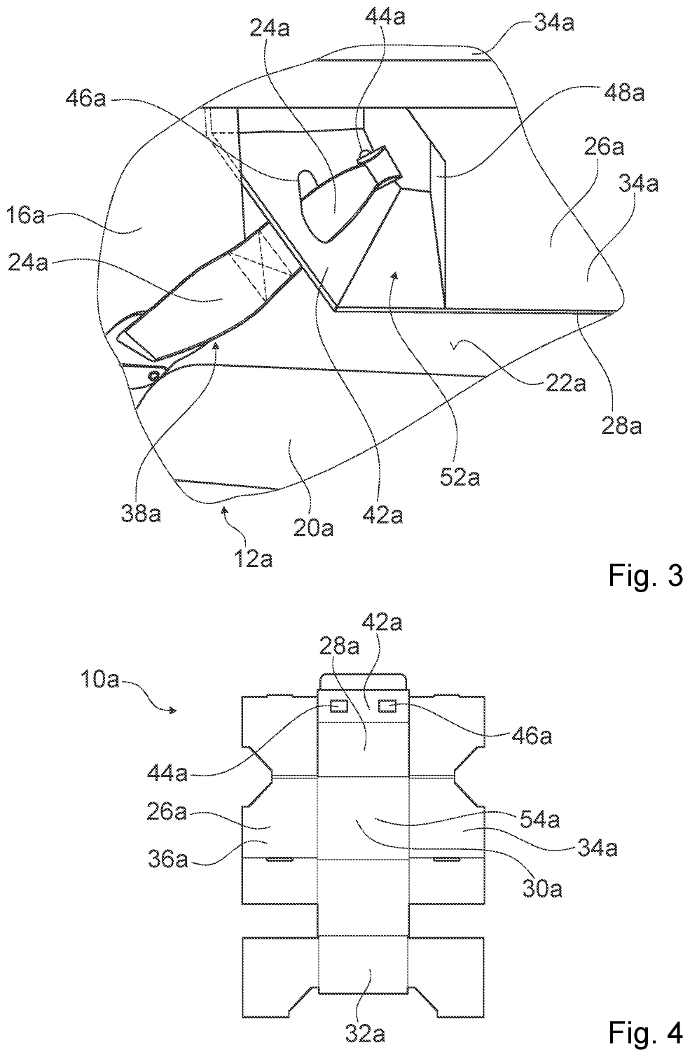

FIGS. 1 to 4 show a first embodiment of an aircraft seat cargo container 10a. The aircraft seat cargo container 10a is configured to be securely fixed to an aircraft seat 12a or an aircraft seat row 14a. The aircraft seat 12a is a seat that is configured to be mounted in an aircraft cabin. In this particular case the aircraft seat 12a is embodied as an economy class aircraft seat. The aircraft seat 12a is preferably part of the seat row 14a. The seat row 14a can consist of two, three or more neighboring aircraft seats 12a. The aircraft seat 12a is provided to be mounted on a cabin floor, not illustrated specifically, of an aircraft, not illustrated specifically. The aircraft seat 12a has a mounting unit which is not illustrated specifically here and via which the aircraft seat 12a is mounted on the cabin floor of the aircraft seat 12a. The aircraft seat 12a comprises a backrest 16a. The backrest 16a is coupled to the mounting unit. It is conceivable here both for the backrest 16a to be rigid or movable and to be coupled to the mounting unit so as to be arrestable in different positions. The backrest 16a forms a backrest surface 18a. The backrest surface 18a is provided in order for a passenger sitting on the aircraft seat 12a to be able to support his/her back on the backrest surface of the backrest 16a. The aircraft seat 12a has a seat bottom 20a. The seat bottom 20a has a basic body embodied as a seat pan and a cushion attached to the basic body. The seat bottom 20a forms a seating area 22a of the aircraft seat 12a. The seat bottom 20a is connected to the mounting unit. The aircraft seat 12a comprises two seat divider elements, which are not shown in detail. The seat divider elements are arranged on the sides of the seat bottom 20a respectively. The aircraft seat 12a further has two armrests, which are not shown in detail. The armrests are preferably pivotally connected to one seat divider respectively. The aircraft seat 12a has an integrated aircraft seat belt 24a. The seat belt 24a is configured as a two-point belt. The seat belt 24a consists of two seatbelt parts which are connectable via a seat belt buckle. Each of the seat belt parts is connected with a first end to one of the seat dividers. It is also conceivable that the seat belt 24a is configured as a three-point belt or another aircraft belt approved for the use in an aircraft.

The aircraft seat cargo container 10a is designated to provide additional storage capacity for air cargo. Alternatively or additionally, the aircraft seat cargo container 10a is designated to provide additional storage capacity for a passenger. Especially for flights in which aircrafts are not fully booked, free aircraft seats 12a can be easily used to provide further storage space for hand luggage of passengers or for other freight transported via the aircraft. The aircraft seat cargo container 10a can be securely fixed to the aircraft seat 12a, without any modifications to the aircraft seat 12a. It is conceivable that the cushion of the seat bottom 20a is removed when particular aircraft seats in an aircraft cabin are dedicated for installation of the aircraft seat cargo container 10a in case the aircraft cabin is used for sole air cargo transport or mixed passenger and air cargo transport, in particular over a period of more than one flight.

The aircraft seat cargo container 10a may be used in different ways. The aircraft seat cargo container 10a may be packed outside of the aircraft and transported to the aircraft seat 12a where it is configured to be installed. Furthermore, the aircraft seat cargo container 10a may be detached from the aircraft seat 12a and transported out of the aircraft in a packed state. Alternatively, the aircraft seat cargo container 10a is fixated on the aircraft seat 12a in an empty state, wherein the aircraft seat cargo container 10a may be filled and emptied inside the aircraft. It is conceivable to have mixed or alternative procedures for the use of the aircraft seat cargo container 10a.

The aircraft seat cargo container 10a may be used on an entire journey of a passenger. It is conceivable that the aircraft seat cargo container 10a is assembled and filled at home of a passenger. On his journey, the passenger carries the aircraft seat cargo container 10a with him. Along the way the aircraft seat cargo container 10a can be placed and/or installed on various seats of different means of transportation, for example in a car, in a bus, in a train, in a vessel or in an aircraft. Thereby, the aircraft seat cargo container 10a may also be used advantageously outside of an aircraft. At the final destination of the passenger's journey, the aircraft seat cargo container 10a may be emptied and dismounted.

The aircraft seat cargo container 10a may also be used as a standardized parcel of a parcel service which can be filled by a customer or by the parcel service. A design of the aircraft seat cargo container 10a may also be optimized for standardized parcel sizes and/or future parcel solutions, for example reusable parcel boxes and/or digitally supported parcel boxes. Thereby, a storage volume 40a of the aircraft seat cargo container 10a can be utilized efficient.

The aircraft seat cargo container 12a comprises a sheet material main body. The sheet material main body is embodied as a cardboard main body 26a. Alternatively, the sheet material main body may be embodied as a sandwich structure main body, a sheet metal main body or any other conceivable main body that has a plate-shaped basic form with abilities for folding. The cardboard main body 26a is made from normal cardboard. The normal cardboard is paper based. It is also conceivable that the cardboard main body 26a consists of a plastic cardboard. The cardboard main body 26a has a width that corresponds to the aircraft seat width. The width of the cardboard main body 26a is smaller than a distance between the armrests of the aircraft seat 12a. The cardboard main body 26a has a bottom wall 28a, a front wall 30a, a back wall 32a and a first and second side wall 34a, 36a. The walls 28a, 30a, 32a, 34a, 36a of the cardboard main body 26a partly define the storage volume 40a of the aircraft seat cargo container 10a. Hand luggage of passengers or other items could be stored in the storage volume 40a defined by the walls 28a, 30a, 32a, 34a, 36a of the cardboard main body 26a. The cardboard main body 26a is provided to be placed on the aircraft seat 12a. With its bottom wall 28a the cardboard main body 26a sits on the seat bottom 20a, especially on the seating area 22a of the seat bottom 20a. The back wall 32a of the cardboard main body 26a is at least partly in contact with the backrest surface 18a of the backrest 16a, when the aircraft seat cargo container 10a is fixed to the aircraft seat 12a. The cardboard main body 26a has two handles 80a. The handles 80a each are embodied as through holes. The handles 80a each are arranged on the first side wall 34a and the second side wall 36a. It is also conceivable that the cardboard main body 26a has an alternative amount of handles or that the handles are arranged at other areas of the cardboard main body 26a.

The aircraft seat cargo container 10a comprises a seating area fastening unit 38a. The seating area fastening unit 38a is provided to secure and fix the cardboard main body 26a to the aircraft seat 12a, in particular the seat bottom 20a of the aircraft seat 12a. For securing the cardboard main body 26a to the aircraft seat 12a, the seating area fastening unit 38a is configured to receive the aircraft seat belt 24a of the aircraft seat 12a. The cardboard main body 26a can be fixed to the aircraft seat 12a via the aircraft seat belt 24a of the aircraft seat 12a. In some instances, especially when the aircraft seat cargo container 10a is not filled with heavy luggage, it is sufficient to secure the cardboard main body 26a only with the aircraft seat belt 24a of the aircraft seat 12a.

The seating area fastening unit 38a is configured to receive the aircraft seat belt 24a to secure the cardboard main body 26a when the storage volume 40a is full. The seating area fastening unit 38a comprises a connection wall 42a. The connection wall 42a is implemented as a slanted wall between the bottom wall 28a and the back wall 32a of the cardboard main body 26a. The connection wall 42a is part of the cardboard main body 26a. The bottom wall 28a of the cardboard main body 26a does not extend to the rear end of the cardboard main body 26a defined by the back wall 32a. The back wall 32a of the cardboard main body 26a does not extend to the bottom of the cardboard main body 26a defined by the bottom wall 28a. The gap between the bottom wall 28a and the back wall 32a is filled by the connection wall 42a. The connection wall 42a has two through holes 44a, 46a, configured to receive the aircraft seat belt 24a to secure the cardboard main body 26a to the aircraft seat 12a. The aircraft seat belt 24a is guided from the one side of the aircraft seat 12a through the first through hole 44a onto an inside of the connection wall 42a and through the second through hole 46a back out to the aircraft seat 12a. In particular, the one seat belt part is guided through the first through hole 44a and the second seatbelt part through the second through hole 46a and connected to one another on the inside of the connection wall 42a via the seat belt buckle. In this way the cardboard main body can be strapped to the aircraft seat 12a via the aircraft seat belt 24a of the aircraft seat 12a. The connection wall 42a has a reinforcement element 50a in the area of the through holes 44a, 46a. The reinforcement element 50a is a coating around the through holes 44, 46 and in an area between both through holes 44a, 46a. The reinforcement elements 50a are provided to enhance the strength of the connection wall 42a in the area where the aircraft seat belt 24a connects to the connection wall 42a. As a result, a durability of the connection wall 42a and therefore a durability of the aircraft seat cargo container 10a can be enhanced. It is also conceivable that the reinforcement element 50a is made in a different way, for example as a glued-on plastic strip. Additionally, the aircraft seat cargo container 10a may comprise protection elements that are arranged in an area of the through holes 44a, 46a. The protection elements are provided for edge protection at the trough holes 44a, 46a. The protection elements are configured for protecting the connection wall 42a and the aircraft seat belt 24a in a mutual manner. The protection elements may be embodied as further reinforcement elements of the connection wall 42a, for example as a foil, or as snap inserts that are configured to be arranged in the through holes 44a, 46a in a form-fit manner.

The cardboard main body 26a includes a separation element 48a. The separation element 48a separates the seating area fastening unit 38a from the storage volume 40a. The separation element 48a is part of the cardboard main body 26a. The separation element 48a is a cardboard wall that extends between the bottom wall 28a and the back wall 32a of the cardboard main body 26a. The separation element 48a is connected to the bottom wall 28a in a distance to the connection wall 42a. The separation element 48a is connected to the back wall 32a in a distance to the connection wall 42a. A mounting space 52a is formed between the connection wall 42a and the separation element 48a. The aircraft seat belt 24a is arranged in the mounting space 52a when the aircraft seat cargo container 10a is fixed to the aircraft seat 12a. A width and height of the mounting space 52a are sized so that a person can fit his hand inside the mounting space 52a. In this way the aircraft seat belt 24a can easily be attached to the connection wall 42a of the cardboard main body 26a. Additionally, it is conceivable that the separation element 48a has an inspection window 82a, for example a transparent foil or a through hole, or a diaphanous perforation, for example a small hole pattern that may be used for visual inspection of the seat belt buckle. Thereby, a connection of the aircraft seat belt 24a with the aircraft seat cargo container 10a can be easily achieved. Moreover, a secure connection of the seat belt buckle can be inspected in an easy manner.

The cardboard main body 26a is formed by one foldable one-piece cardboard element 54a. The bottom wall 28a, the front wall 30a, the back wall 32a, the side walls 34a, 36a, the connection wall 42a and the separation element 48a are formed by the one foldable one-piece cardboard element 54a. FIG. 4 shows the one-piece cardboard element 54a in an unfolded, flat state. A folding of the one-piece cardboard element 54a shown in FIG. 4 slightly deviates from the cardboard main body 26a shown in FIGS. 1 to 3. The one-piece cardboard element 54a has cuts and or bend lines between the different wall elements 28a, 30a, 32a, 44a, 36a, 42a, 48a that form the cardboard main body 26a. The different wall elements 28a, 30a, 32a, 44a, 36a, 42a, 48a are folded to form the cardboard main body 26a and are connected in a form-fit fashion. Some of the wall elements 28a, 30a, 32a, 44a, 36a, 42a, 48a, in particular the side walls 34a, 36a are implemented double-walled, to enhance the structural integrity of the cardboard main body 26a. The cardboard main body 26a is configured to be foldable between the flat state and a state that defines the storage volume 40a multiple times. After being folded up to form the storage volume 40a, all wall elements 28a, 30a, 32a, 44a, 36a, 42a, 48a of the cardboard main body 26a can be unfolded in the flat state.

The aircraft seat cargo container 10a comprises a closing element 56a. The closing element 56a is configured to close an insert opening of the cardboard main body 26a. The closing element 56a is implemented as a separate lid. The closing element 26a is made from cardboard. The closing element 56a has a rim that encompasses the side walls 34a, 36a, the front wall 30a and the back wall 32a in an upper area. Thereby the closing element 56a can be fixed to the upper side of the cardboard main body 26a and close the storage volume 40a.

The seating area fastening unit 38a has one aircraft seat fastening element 76a, via which the cardboard main body 26a can be additionally secured to the aircraft seat 12a. The aircraft seat fastening element 76a is implemented as an elastic loop. The aircraft seat fastening element 76a is guided around the cardboard main body 26a, especially in an upper region, and secured to the backrest 16a. To secure the aircraft seat fastening element 76a to the backrest 16a, the aircraft seat fastening element 76a is guided around the backrest 16a. Alternatively, it is also conceivable that the aircraft seat fastening element 76a is implemented as an elastic strap and fixed to the seat divider or the armrests of the aircraft seat 12a with its respective ends.

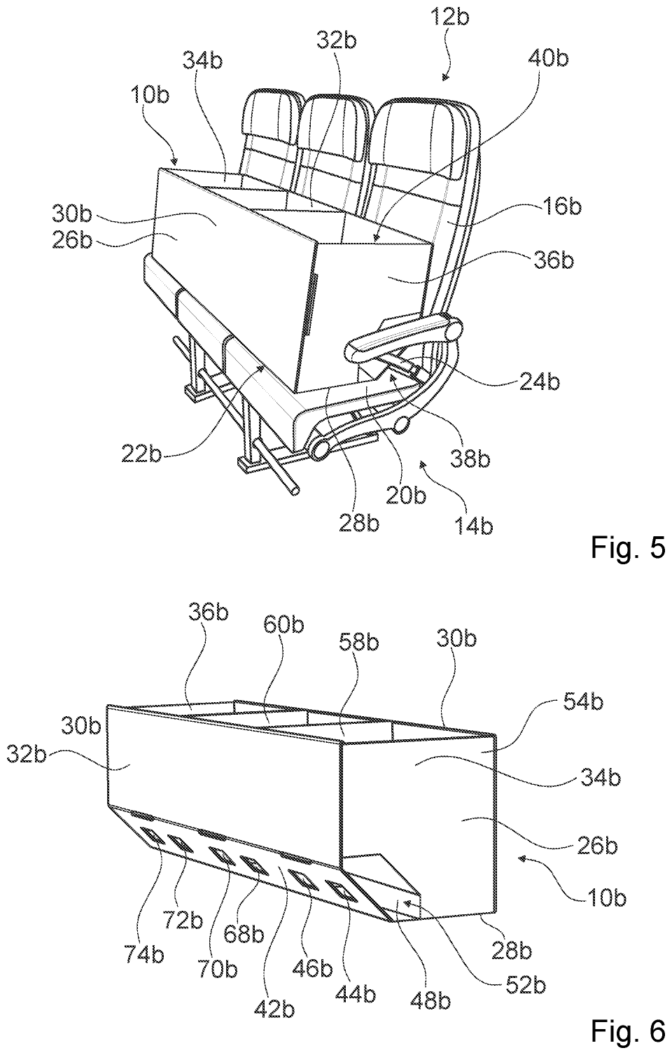

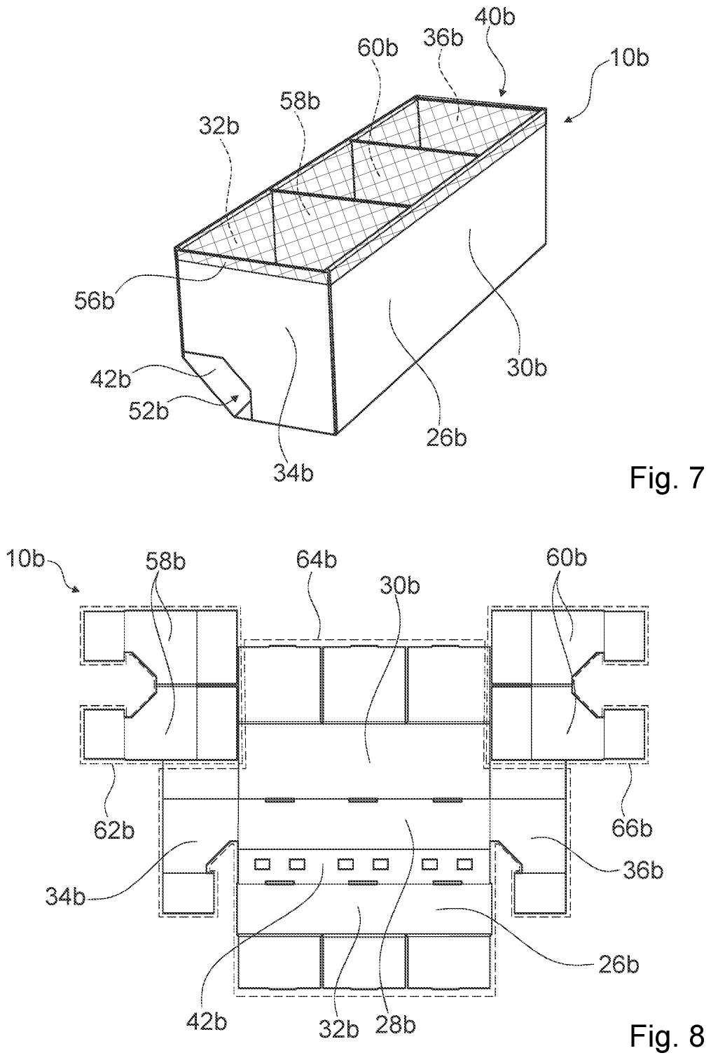

FIGS. 5 to 10 show three further embodiments of the invention. The following description and the figures are essentially restricted to the differences between the exemplary embodiments, wherein regarding equally denominated components, in particular regarding components with the same reference numeral, the figures and/or description from the other exemplary embodiments, in particular of FIGS. 1 to 4, may be considered. For distinguishing the exemplary embodiments, the letter “a” has been added to the reference numerals of the exemplary embodiment of FIGS. 1 to 4, wherein, in the exemplary embodiments of FIGS. 5 to 10, the letter “a” has been replaced by the letters “b” to “d”.

FIGS. 5 to 8 show a second embodiment of an aircraft seat cargo container 10b. The aircraft seat cargo container 10b is configured to be securely fixed to an aircraft seat row 14b. The aircraft seat row 14b comprises an aircraft seat 12b. An aircraft seat 12b is a seat that is configured to be mounted in an aircraft cabin. The aircraft seat 12b is preferably part of the seat row 14b. The seat row 14b can consist of two, three or more neighboring aircraft seats 12b. In the present case, the aircraft seat row consists of three aircraft seats 12b. The aircraft seat row 14b embodies an aircraft seat bench.

The aircraft seat cargo container 10b is designated to provide additional storage capacity for air cargo. Alternatively or additionally, the aircraft seat cargo container 10b may be designated to provide additional storage capacity for a passenger. The aircraft seat cargo container 10b can be securely fixed to the aircraft seats 12b, without any modifications to the aircraft seats of the aircraft seat row 14b. In contrast to the first embodiment, the aircraft seat cargo container 10b spans three neighboring aircraft seats of the seat row 14b.

The aircraft seat cargo container 10b comprises a sheet material main body. The sheet material main body is embodied as a cardboard main body 26b. The cardboard main body 26b is made from a plastic cardboard. The cardboard main body 26b has a width that corresponds to the width of three neighboring aircraft seats. The cardboard main body 26b has a bottom wall 28b, a front wall 30b, a back wall 32b and a first and second side wall 34b, 36b. The walls 28b, 30b, 32b, 34b of the cardboard main body 26b partly define a storage volume 40b of the aircraft seat cargo container 10b. The cardboard main body 26b further has two compartment walls 58b, 60b. The compartment walls 58b, 60b separate the storage volume 40b in three separate compartments inside the storage volume 40b. The compartment walls 58b, 60b are part of the cardboard main body 26b.

The aircraft seat cargo container 10b comprises a seating area fastening unit 38b. The seating area fastening unit 38b is provided to secure and fix the cardboard main body 26b to the three neighboring aircraft seats of a seat row, in particular to seat bottoms of these aircraft seats. For securing the cardboard main body 26b to the aircraft seats, the seating area fastening unit 38b is configured to receive aircraft seat belts of the aircraft seats. The cardboard main body 26b can be fixed to the aircraft seats of the seat row via the aircraft seat belts of the aircraft seats. In some instances, especially when the aircraft seat cargo container 10b is not filled with heavy luggage, it is sufficient to secure the cardboard main body 26b only with the aircraft seat belt of the middle aircraft seat or the two outer aircraft seats.

The seating area fastening unit 38b is configured to receive the aircraft seat belts of the aircraft seats the cardboard main body 26b is placed upon, to secure the cardboard main body 26b when the storage volume 40b is full. The seating area fastening unit 38b comprises a connection wall 42b. The connection wall 42b is implemented as a slanted wall between the bottom wall 28b and the back wall 32b of the cardboard main body 26b. The connection wall 42b is part of the cardboard main body 26b. The connection wall 42b has six through holes 44b, 46b, 68b, 70b, 72b, 74b configured to receive the aircraft seat belts to secure the cardboard main body 26b to the aircraft seats of the seat row. The connection wall 42b has two through holes 44b, 46b, 68b, 70b, 72b, 74b for every aircraft seat belt. Each aircraft seat belt can be secured to a pair of through holes 44b, 46b, 68b, 70b, 72b, 74b to fix the cardboard main body 26b to the aircraft seats of the seat row.

The cardboard main body 26b is formed by one foldable one-piece cardboard element 54b. The bottom wall 28b, the front wall 30b, the back wall 32b, the side walls 34b, 36b, the connection wall 42b, the separation element 48b and the compartment walls 58b, 60b are formed by the one foldable one-piece cardboard element 54b. In contrast to the first embodiment, the one-piece cardboard element 54b comprises three adhesively joined cardboard elements 62b, 64b, 66b. The smaller cardboard elements 62b, 64b, 66b are adhesively joined to form the one-piece cardboard element 54b that forms the cardboard main body 26b. FIG. 8 shows the one-piece cardboard element 54b in an unfolded, flat state.

The aircraft seat cargo container 10b comprises a closing element 56b. The closing element 56b is configured to close an insert opening of the cardboard main body 26b. The closing element 56b comprises an elastic net that can be put over the upper side of the cardboard main body 26b. The cardboard main body 26b may have fixation elements configured to fixate the closing element 56b to the cardboard main body 26b. The fixation elements may be integral parts of the cardboard main body 26b which are folded out of an upper edge of the aircraft seat cargo container 10b. Alternatively or additionally, the cardboard main body 26b may have hooking holes as fixation elements that are preferably reinforced.

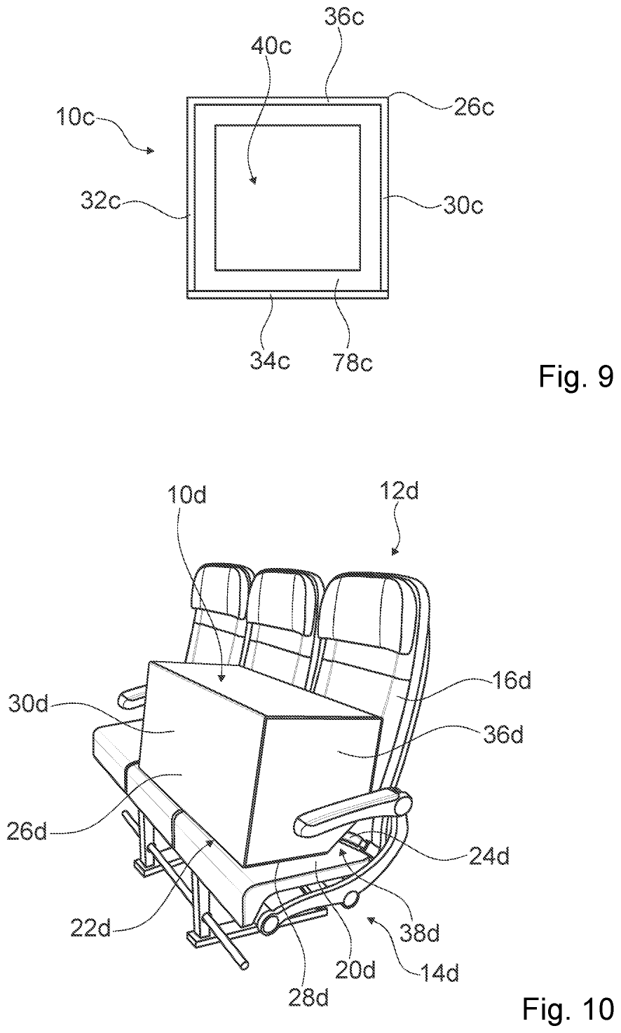

FIG. 9 shows a third embodiment of an aircraft seat cargo container 10c. In general, the aircraft seat cargo container 10c is similar to the one of the first embodiment. The aircraft seat cargo container 10c comprises a sheet material main body. The sheet material main body is embodied as a cardboard main body 26c. The cardboard main body 26c has a bottom wall 28c, a front wall 30c, a back wall 32c and a first and second side wall 34c, 36c. The walls 28c, 30c, 32c, 34c of the cardboard main body 26c partly define a storage volume 40c of the aircraft seat cargo container 10c. In difference to the first embodiment, the cardboard main body 26c includes an insulation inlay 78c. The insulation inlay 78c is made from an insulating material. The insulation inlay 78c is placed inside the storage volume 40c and forms an insulated cargo space. With the insulation inlay 78c a cooling container can be obtained. The cardboard main body 26c further comprises a closing element, which is also insulated.

FIG. 10 shows a fourth embodiment of an aircraft seat cargo container 10d. In general, the aircraft seat cargo container 10d is similar to the one of the first embodiment and the second embodiment. The aircraft seat cargo container 10d is configured to be securely fixed to an aircraft seat row 14d. The aircraft seat row 14d comprises an aircraft seat 12d. The aircraft seat 12d is part of the seat row 14d. The seat row 14d consists of three neighboring aircraft seats 12d. The aircraft seat row 14d embodies an aircraft seat bench. The aircraft seat 12d has an integrated aircraft seat belt 24d. The aircraft seat belt 24d is configured as a two-point belt. The aircraft seat belt 24d consists of two seatbelt parts which are connectable via a seat belt buckle of the aircraft seat belt 24d. The aircraft seat cargo container 10d comprises a sheet material main body. The sheet material main body is embodied as a cardboard main body 26d. The cardboard main body 26d has a bottom wall 28d, a front wall 30d, a back wall and a first side wall and a second side wall 36d. The walls 28d, 30d, 36d of the cardboard main body 26d partly define a storage volume of the aircraft seat cargo container 10d. In contrast to the second embodiment, the aircraft seat cargo container 10d spans two neighboring aircraft seats 12d of the seat row 14d. The cardboard main body 26d has a width that corresponds to the width of two neighboring aircraft seats 12d. One of three aircraft seats 12d is not over spanned by the aircraft seat cargo container 10d. Thereby it is possible that a passenger is seated on one of the aircraft seats 12d, wherein the aircraft seat cargo container 10d is installed directly next to the passenger.

Furthermore, in contrast to the first and second embodiment of the invention, the sheet material main body, in particular the cardboard main body 26d, has no separation element. Advantageously, this may be the case when the aircraft seat cargo container 10d is configured to be installed in an aircraft cabin over a period of more than one flight, wherein the storage volume of the aircraft seat cargo container 10d has to be filled and emptied inside the aircraft cabin. By omitting the separation element of the first and second embodiment, an advantageously large storage volume of the aircraft seat cargo container 10d can be provided. In contrast to the first and second embodiment of the invention, a mounting space is embodied inside the storage volume. The aircraft seat belt 24d is arranged in the mounting space when the aircraft seat cargo container 10d is fixed to the aircraft seat 12d. The seat belt buckle of the aircraft seat belt 24d is arranged in the storage volume when the aircraft seat cargo container 10d is fixed to the aircraft seat 12d. In the present case, the first side wall and the second side wall 36d do not have cut-outs providing access to the mounting space as shown in the first and second embodiment.

### REFERENCE NUMERALS

10 aircraft seat cargo container
12 aircraft seat
14 seat row
16 backrest
18 backrest surface
20 seat bottom
22 seating area
24 aircraft seat belt
26 cardboard main body
28 bottom wall
30 front wall
32 back wall
34 side wall
36 side wall
38 seating area fastening unit
40 storage volume
42 connection wall
44 through hole
46 through hole
48 separation element
50 reinforcement element
52 mounting space
54 one-piece cardboard element
56 closing element
58 compartment wall
60 compartment wall
62 cardboard elements
64 cardboard elements
66 cardboard elements
68 through hole
70 through hole
72 through hole
74 through hole
76 aircraft seat fastening element
78 insulation inlay
80 handle
82 inspection window

1. An aircraft seat cargo container, comprising:
a sheet material main body, in particular a cardboard main body, having a bottom wall, a back wall, a front wall and first and second side walls that define a storage volume; and
a seating area fastening unit configured to receive an aircraft seat belt for securing the sheet material main body.

2. The aircraft seat cargo container according to claim 1, wherein the seating area fastening unit is configured to receive the seat belt to secure the sheet material main body when the storage volume is full.

3. The aircraft seat cargo container according to claim 2, wherein the sheet material main body includes a separation element that separates the fastening unit from the storage volume.

4. The aircraft seat cargo container according to claim 1, wherein the fastening unit further comprises a connection wall, the connection wall defining at least one through hole, configured to receive the seat belt to secure the sheet material main body to the seat.

5. The aircraft seat cargo container according to claim 1, wherein the connection wall is implemented as a slanted wall between the bottom wall and the back wall.

6. The aircraft seat cargo container according to claim 1, wherein the fastening unit has at least one aircraft seat fastening element, via which the sheet material main body can be additionally secured to the aircraft seat.

7. The aircraft seat cargo container according to claim 1, wherein the sheet material main body has a width that corresponds to a seat width.

8. The aircraft seat cargo container according to claim 1, wherein the sheet material main body has a width that corresponds to the width of at least two neighboring aircraft seats.

9. The aircraft seat cargo container according to claim 1, further comprising a closing element that is configured to close an insert opening of the sheet material main body.

10. The aircraft seat cargo container according to claim 9, wherein the closing element comprises a separate lid.

11. The aircraft seat cargo container according to claim 9, wherein the closing element comprises an elastic net.

12. The aircraft seat cargo container according to claim 1, wherein the sheet material main body is formed by one foldable one-piece cardboard element.

13. The aircraft seat cargo container according to claim 12, wherein the sheet material main body is configured to be foldable between a flat state and a state that defines the storage volume multiple times.

14. The aircraft seat cargo container according to claim 12, wherein the one-piece cardboard element comprises a plurality of adhesively joined cardboard elements.

15. The aircraft seat cargo container according to claim 1, wherein the sheet material main body includes an insulation inlay.
